(19) United States
(12) Patent Application Publication
(10) Pub. No.: US 2011/0209574 A1
(43) Pub. Date: Sep. 1, 2011

(54) POWER LEVER FOR SCOOTER

(75) Inventor: CHEN-CHI HSIAO, CHIA YI CITY (TW)

(73) Assignee: SUNPEX TECHNOLOGY CO., LTD., CHIA YI CITY (TW)

(21) Appl. No.: 12/713,435

(22) Filed: Feb. 26, 2010

(51) Int. Cl. G05G 11/00

(52) U.S. Cl. 74/481

(57) ABSTRACT

A power lever for scooters is reveled. The power lever is arranged at one of the two sides of a scooter stem and is electrically connected with a power switch and a controller both of which are mounted in the scooter stem. Moreover, a linkage lever is disposed on the other side of the scooter stern, opposite to the power lever while an auxiliary lever is connected between the power lever and the linkage lever and is located on a rear side of the scooter stern. Thereby users can use the other hand to operate the power lever so as to avoid safety problems caused by a stop of scooters in the road in the case the user who feels a sudden pain in one hand is unable to drive the scooter.

### BACKGROUND OF TIM INVENTION

1. Fields of the Invention

The present invention relates to a power lever for scooters, especially to a power lever for scooters that can be operated by a user's hands and legs so as to avoid safety problems caused by a stop of scooters in the road in the case the user who feels a sudden pain in one hand is unable to drive the scooter.

2. Descriptions of Related Art

Some people are paralyzed below the waist due to serious injuries in car accidents or a stroke caused by a serious illness. Some are patients confined by illness and unable to walk that. These conditions result in muscular atrophy and weakness in their legs. Some are older people that move slowly because of their physical conditions that impair mobility or balance. Once these handicapped people intend to move or walk, they all need mobility aids such as wheelchairs or crutches that help them move around. However, these mobility aid devices are operated manually. This is not only energy consuming but the moving speed is also limited. Thus some manufactures have invented various transport vehicles such as electric scooters and electric wheelchairs. By the power from electricity, handicapped people can move more easily and conveniently.

Electric scooters available now include a power system that drives scooters to move. A power lever is assembled on left side or right side of a handle of a scooter. Then the power lever is connected with a power switch, When the power lever is pushed, the power switch and a controller are turned on so as to drive the scooter moving forward backward or standing still.

However, most of users of scooters are weak people or elders whose psychological functions are impaired. When their hands that control the power lever are injured or disabled, they are unable to operate the scooter and the scooter will not function as a mobility aid. Moreover, once the scooter is out of order and stopped in the road, this leads to traffic congestion and also jeopardizes the scooter user's safety.

Furthermore, some of scooters available now include parts such as a power lever, a power switch and a controller arranged in different positions so as to meet requirements of different users such as people who have injuries to hands or different handedness. Thus manufacturing processes cannot be simplified and this results in inconvenience in production of scooters.

Due to the design of the power lever arranged at the left side or the right side of the handle of the scooter available now, the scooter will not run once the user's hand near that side is disabled or injured and unable to operate the power lever. Thus there is a need to invent scooters with novel power lever design that overcomes above disadvantages.

### SUMMARY OF THE INVENTION

Therefore it is a primary object of the present invention to provide a power lever for scooters that can be operated by user's two hands and legs so as to avoid traffic safety problems caused by a sudden stop of the scooter in the road in the case that the user feels pain in one hand and cannot drive the scooter.

In order to achieve above object, a power lever for scooters of the present invention is disposed on one of the two sides of a scooter stem and is electrically connected with a power switch and a controller both of which are mounted in the scooter stem. Moreover, a linkage lever is arranged at the other side of the scooter stern, opposite to the power lever while an auxiliary lever is connected between the power lever and the linkage lever and is located on a rear side of the scooter stem.

Thereby users can use the other hand or their legs to operate the power lever so as to prevent the scooter from being hit by another car and jeopardizing user's safety in the case the scooter is accidentally stopped in the road when users feel pain or have hand injury in one hand and cannot operate the power lever.

Moreover, the scooter with the present invention can be operated by both hands and legs so that it is suitable for users with various injuries to the hand or with different handedness. There is no need to arrange the power lever and other parts such as a power switch and a controller at different positions during assembling processes for meeting requirements of various users. Thus the production processes are simplified due to the uniform specification of parts and the manufacturing of the scooter becomes easier and more flexible.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is top view of an embodiment according to the present invention;

FIG. 3 is a schematic drawing showing an embodiment of the present invention in use;

FIG. 4 is a schematic drawing showing an embodiment of the present invention in use.

### DETAILED DESCRIPTION OF THE PREFERRED EMBODIMENT

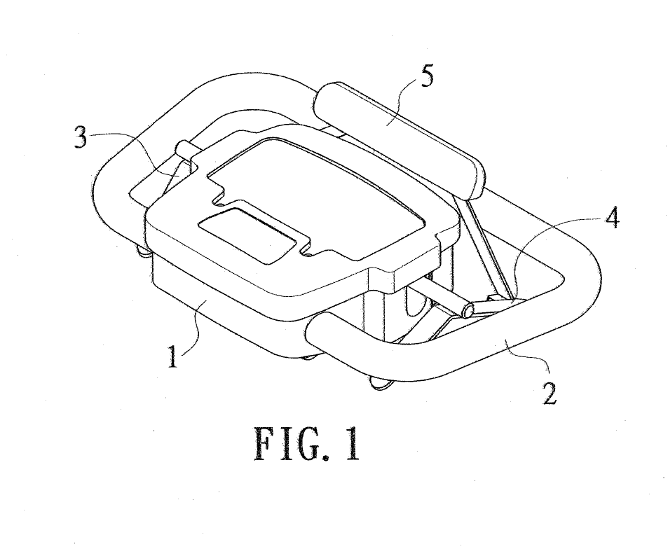

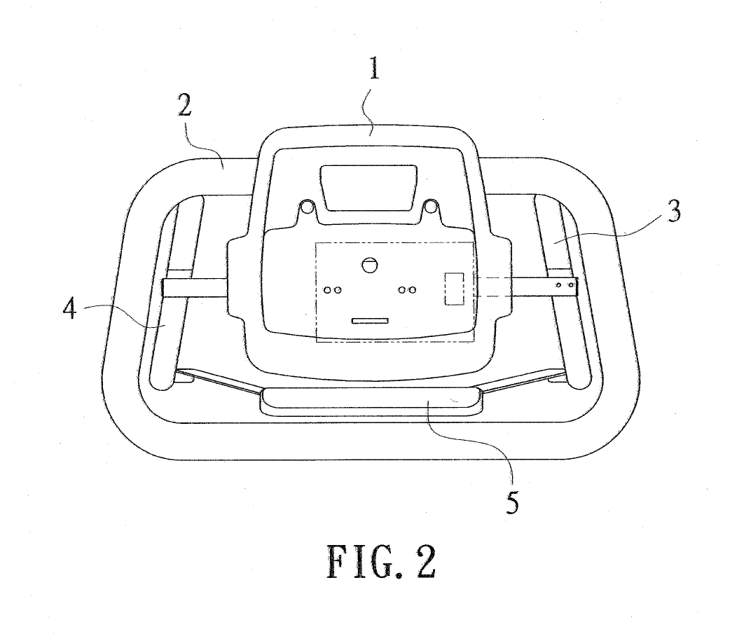

Refer to FIG. 1 and FIG. 2, a power lever for scooters according to the present invention mainly includes a circular handle 2 assembled on a scooter stem 1. One of the two sides-right or left-of the scooter stem 1 is assembled with a power lever 3 that is electrically connected with a power switch and a controller both of which are mounted inside the scooter stem 1. Moreover, the other side of the scooter stem 1, opposite to the power lever 3, is disposed with a linkage lever 4. An auxiliary lever 5 is connected between the power lever 3 and the linkage lever 4 and is located on a rear side of the scooter stem 1.

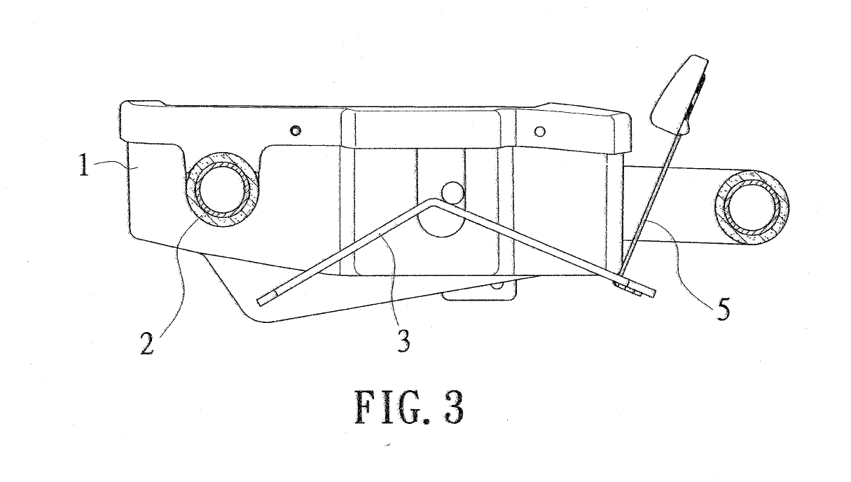

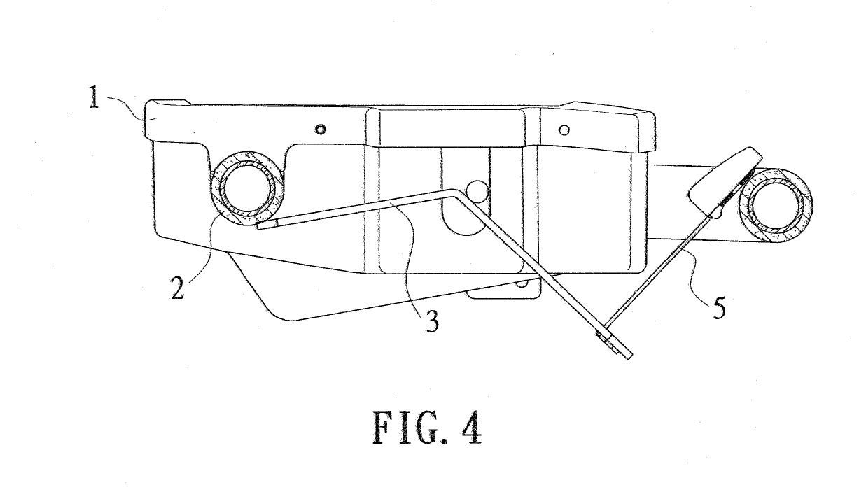

Thereby when scooter users' hand near the side with the power lever 3 is suddenly disabled or injured and unable to operate the power lever 3, they can use the other hand to operate the linkage lever 4 or the auxiliary lever 5, as shown in FIG. 3 and FIG. 4. Now the linkage lever 4 as well as the auxiliary lever 5 connected with the power lever 3 can also move and act together with the power lever 3 so as to drive the scooter moving forward, moving backward, or standing still.

Thus the shortcomings of conventional scooters with a power lever only on one side such as a sudden stop of the scooter due to temporarily disability or injury of user's hand that loses control of the power lever, traffic congestion and driver safety, can all be overcome.

Furthermore, the production processes are simplified due to the uniform specification of parts and the inconvenience in production is reduced. There is no need to modify the scooters and change positions of the parts such as power levers and power switches for satisfying the requirements of users with various injuries to the hand or with different handedness.

In summary, compared with the structure available now, the present invention has following advantages:

1. In the present invention, the power lever electrically connected with the power switch and the controller is joined with the linkage lever disposed on the opposite side of the power lever by the auxiliary lever on a rear side of the scooter stem. Thereby once the users feel a sudden pain in their hands or injure their hands and cannot operate the power lever, they can use the other hand to access the power lever so as to avoid traffic congestion or prevent the scooter from being hit by another car and jeopardizing user's safety in the case the scooter is accidentally stopped in the road.
2. By a simple design in which the power lever is connected with an auxiliary lever extended backward and a linkage lever is disposed opposite to the power lever, the scooter with the present invention is suitable for users with various injuries to the hand or with different handedness, Thus the production processes are simplified due to the uniform specification of parts and the manufacturing of the scooter becomes easier and more flexible.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A power lever for scooters comprising:
a power lever that is disposed on one of two sides of a scooter stem and is electrically connected with a power switch and a controller that are mounted in the scooter stem;
a linkage lever that is arranged at the other side of the scooter stem, opposite to the power lever; and
an auxiliary lever that is connected between the power lever and the linkage lever and is located on a rear side of the scooter stern.

2. The device as claimed in claim 1, wherein the scooter stem is connected with a circular handle.
